(19) United States
(12) Patent Application Publication
(10) Pub. No.: US 2016/0227077 A1
(43) Pub. Date: Aug. 4, 2016

(54) DIGITAL IMAGING CAMERA UNIBODY HOUSING AND METHOD FOR ASSEMBLING ELECTRONICS INSIDE THE HOUSING

(71) Applicants: Maxim Mudruk, Kyiv (UA); Mykola Seleznov, Kyiv (UA); Farhad Towfiq, Oceanside, CA (US)

(72) Inventors: Maxim Mudruk, Kyiv (UA); Mykola Seleznov, Kyiv (UA); Farhad Towfiq, Oceanside, CA (US)

(73) Assignee: SUMIX, Oceanside, CA (US)

(21) Appl. No.: 14/608,383

(22) Filed: Jan. 29, 2015

(51) Int. Cl. H04N 5/225

(52) U.S. Cl. CPC H04N 5/2252

(57) ABSTRACT

Digital imaging camera housing of generally but not exclusively circular or rectangular shape has one body element closed from all other sides except from the lens mount. The body element contains at least one opening for a communication connector. The camera assembly method allows installing camera circuit board into the housing through the open lens mount side and attaching it to the housing inner side with screws, locks, latches or any other type of fixture. Camera electronics can be protected from the lens mount side of the housing with a piece of transparent material, preferably glass, for example with an infrared cut-off filter.

### CROSS-REFERENCE TO RELATED APPLICATIONS

Provisional application No. U.S. 61/874,387, filed on Jun. 9, 2013.

### BACKGROUND

1. Field of the Invention

The disclosed invention relates to digital imaging cameras particularly but not exclusively for industrial, machine-vision, scientific, medical and CCTV applications.

2. Description of the Related Art

Conventional imaging cameras consist of multiple parts including housings with lens mount flanges, electronic circuit boards, infrared cut-off filters and interface connectors. Manufactures look for ways to produce damage resistant, cheap and environmentally protected housing for cameras.

Embodiments of the present invention aim to provide easily manufactured and assembled miniature digital cameras which are more robust and better protected than conventional imaging cameras.

It is a usual manufacturing practice to produce the housing from parts and to join them by screws or other connection elements. Junctures can let moisture or dust into the camera. The advantage of the disclosed camera model is a unibody housing which provides better environmental protection. Camera hermiticity ensures stability and durability of operation.

Another advantage of the unibody housing is that it is cheaper, easier and quicker to produce and more convenient to use.

The advantage of the disclosed camera assembling method is its quickness and simplicity. The camera parts are inserted into the housing through the lens flange and joined together by a fixture ring or screws in one operation.

### SUMMARY OF THE INVENTION

The disclosed digital imaging camera housing has generally circular or rectangular shape, with at least one body element. The housing is closed from all sides except from the lens mount and contains at least one communication connector. The preferred embodiments are represented on the drawings for two different lens types: C-mount or bayonet.

The camera circuit board is installed into the housing through the open lens mount side. Then the board is attached to the inner side of the housing with screws, locks, latches or any other fixture type.

The camera electronics can be protected from the lens mount side of the housing with a piece of transparent material, preferably glass. An infrared cut-off filter can be used for this purpose.

### BRIEF DESCRIPTION OF THE DRAWINGS

The drawings present two examples of the camera housing with two different lens types. The camera assembling method illustrated for these examples is also suitable for other types of lens mounts.

FIG. 1a is an exploded perspective view of the imaging camera assembly parts with the C-mount lens and the circuit board fixed with fixture ring. The lens 7 shown on the view is not part of the basic camera assembly and is included for illustration purposes.

FIG. 1b is a cross-sectional side view of the imaging camera represented on of FIG. 1a in the assemblage condition.

FIG. 2a is an exploded perspective view of the imaging camera assembly parts with the bayonet lens mount and the circuit board fixed with screws.

FIG. 2b is a cross-sectional side view of the imaging camera represented on FIG. 2a in the assemblage condition.

FIG. 3 illustrates the camera assembling method in which the circuit board is fixed inside the housing by a fixture ring.

FIG. 4 illustrates the camera assembling method in which the circuit board is fixed inside the housing by two screws.

### REFERENCE NUMERALS IN THE DRAWINGS

| | |
|---|---|
| 1 unibody housing for | 2 C-mount flange |
| C-mount lens | |
| 3 circuit board | 4 image sensor |
| 5 fixture ring | 6 infrared cut-off filter |
| 7 C-mount lens | 8 communication connector |
| 9 opening | 13 unibody housing for bayonet lens |
| 14 bayonet flange | 15 circuit board |
| 16, 16′ screw holes | 17 image sensor |
| 18 diaphragm | 19, 19′ screw holes |
| 20, 20′ screws | 21 mounting hole |
| 22 communication connector | 23 opening |

### DETAILED DESCRIPTION OF THE INVENTION

Reference will now be made in detail to the particular embodiments illustrated in the accompanying drawings.

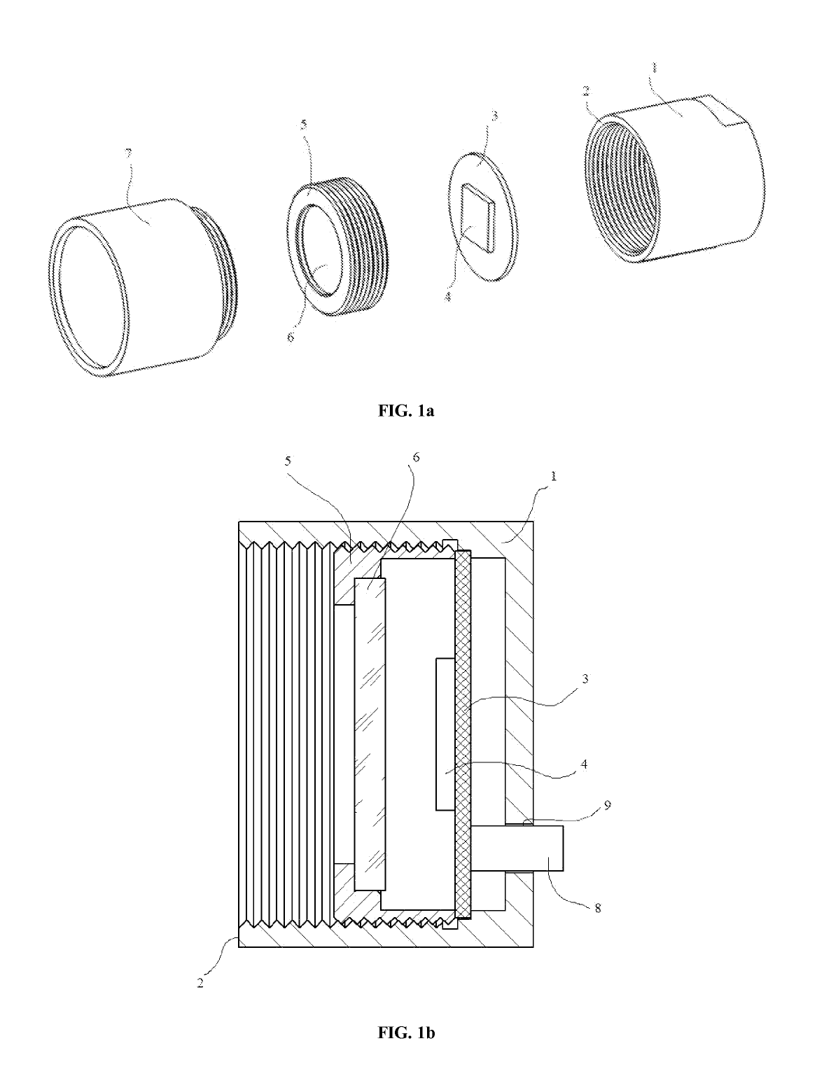

FIG. 1a illustrates parts of the camera assembly with C-mount lens according to the first embodiment of the present invention. As shown in FIG. 1a, the camera assembly parts include unibody housing 1 with C-mount flange 2, circuit board 3 with digital sensor 4, and fixture ring 5 with infrared cut-off filter 6. The C-mount lens 7 is not part of the basic camera assembly and can be connected later.

The unibody housing can be milled from one piece of metal, casted metal, or stamped plastic. Its inside diameter is defined by (but not limited to) the size of the lens mount.

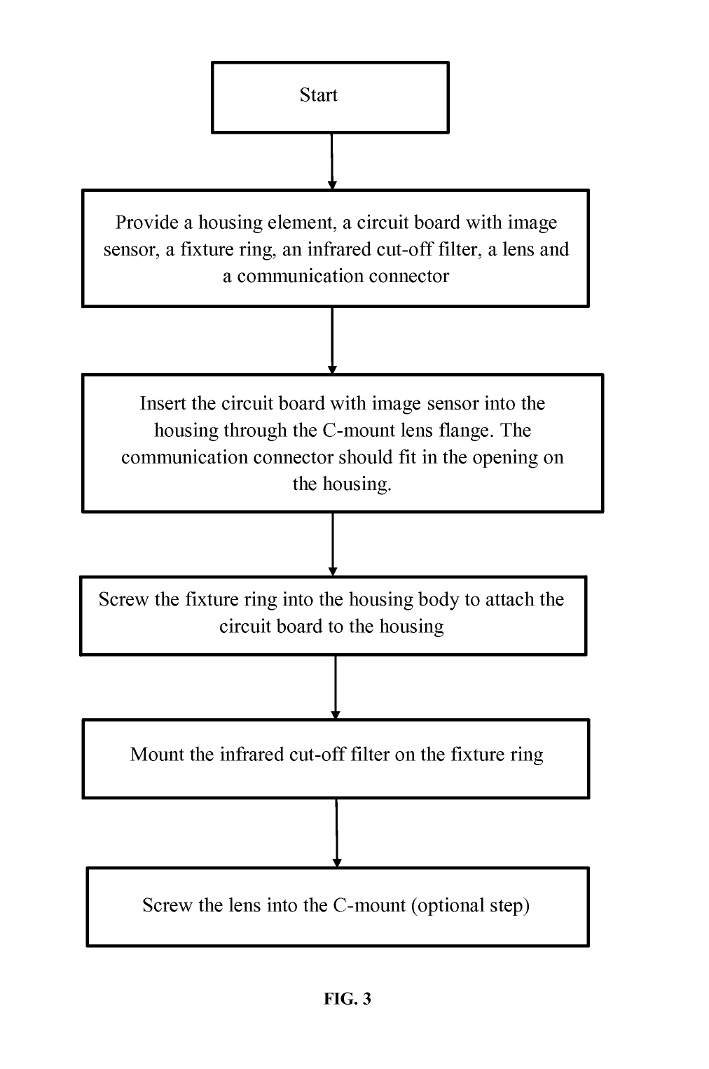

FIG. 3 describes the method of assembling the camera parts shown on FIG. 1a. Circuit board 3 with image sensor 4 is inserted into the unibody housing 1 through the C-mount lens flange 2. The circuit board 3 is inserted into the housing the way that the communication connector 8 on the circuit board fits in the opening 9 on the housing.

The circuit board 3 is attached to the body with fixture ring 5. The fixture ring 5 is screwed into the housing 1 to force the circuit board 3 against the inner back side of the housing. The circuit board 5 should be designed so that some free space on its edge is left for the fixture ring for producing connection. Infrared cut-off filter 6 is mounted on the fixture 5. Then lens 7 is screwed into the C-mount flange 2.

There is at least one opening 9 in the housing 1 for inserting communication connector 8, as shown in FIG. 1.b. The number, shape and size of the openings are defined by the camera design. They can be located on back or side surface of the housing and serve for communication connectors, indicators or other functions.

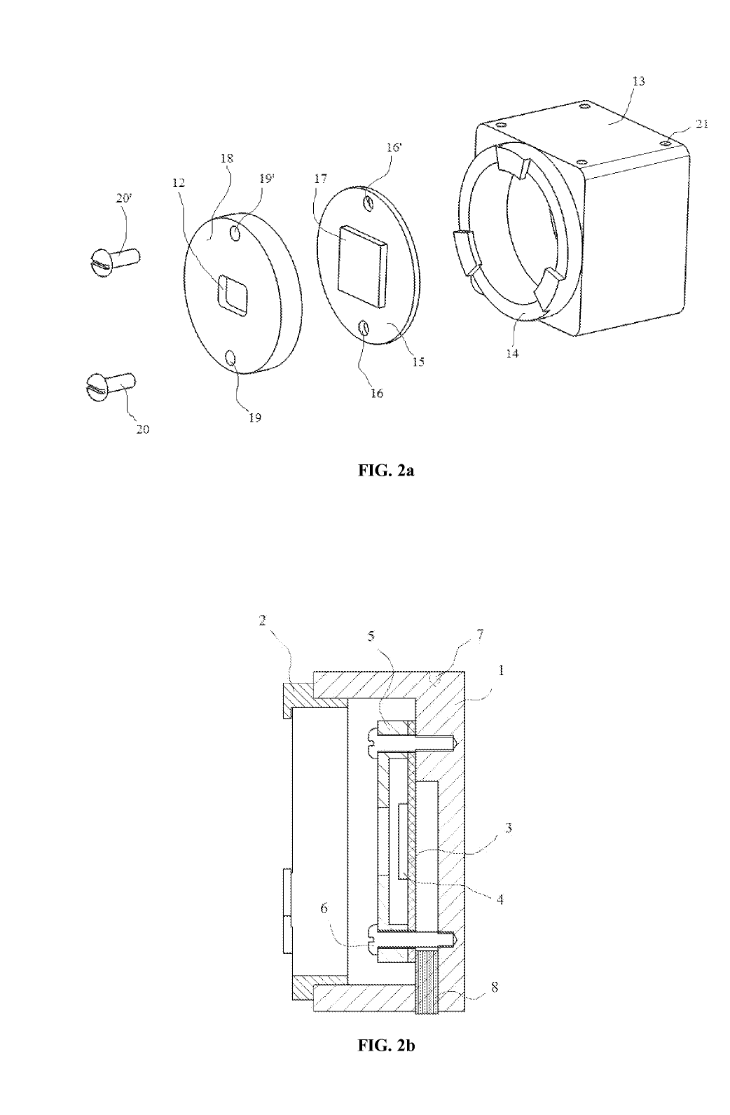

Another embodiment example of the invention is the camera assembly with a bayonet lens mount shown on FIG. 2a. The assembly parts include unibody housing element 13, circuit board 15 with image sensor 17 and diaphragm 19 with opening 12. Both the circuit board and the diaphragm have screw holes marked with numbers 16, 16′ and 19, 19′ respectively for screws 20, 20′. The four mounting holes 21 shown in this embodiment can be used for mounting the camera.

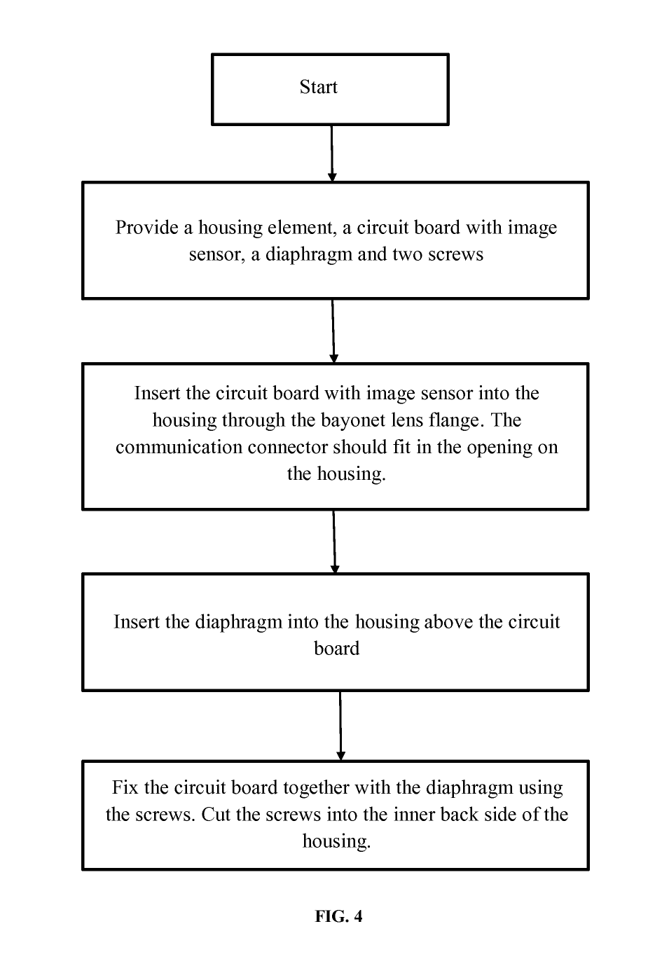

FIG. 4 describes the method of assembling the camera parts shown on FIG. 1b. Circuit board 15 with image sensor 17 is inserted into the unibody housing 13 through the bayonet lens flange 14. The board 15 and the diaphragm 18 are fitted together inside the camera body with two screws 20 and 20′. The screw threads are cut into the inner back side of the housing 1.

We claim:

1. Digital imaging camera housing, comprising:
one outer body which does not require any fastener, for example screws, outside to hold any camera components inside the housing, or to hold the housing parts together,
the body milled from one machined piece of metal, one casted piece of metal, or one stamped piece of plastic.

2. A method for assembling electronics inside the camera housing defined in claim 1.
